(19) United States
(12) Patent Application Publication
(10) Pub. No.: US 2005/0074731 A1
(43) Pub. Date: Apr. 7, 2005

(54) Time-out educational system

(76) Inventor: Ann Brazil, San Marino, CA (US)

Correspondence Address: CHRISTIE, PARKER & HALE, LLP, PO BOX 7068, PASADENA, CA, 91109-7068, US

(21) Appl. No.: 10/681,038

(22) Filed: Oct. 7, 2003

(51) Int. Cl. G09B 19/00

(52) U.S. Cl. 434/236

(57) ABSTRACT

A method of educating a child during a time-out period. A caregiver identifies a child misbehaving and isolates the child from any distractions. The caregiver then selects an educational time-out presentation from a plurality of educational time-out presentations by topic based on the child's misbehavior. After the child views the educational time-out video, caregiver continues to monitor the child to confirm if the child is behaving in accordance with the educational time-out video. Each educational time-out presentation includes a non-threatening yet authoritative figure that leads the child through an educational process using visual, auditory, and kinesthetic methods wherein the child learns to make more appropriate decisions about how to behave.

### BACKGROUND OF THE INVENTION

This invention pertains generally to the education of children and more specifically to providing a structured and mediated learning environment for young children.

One method for correcting misbehavior in children includes the use of a “time-out” period. During a time-out period, a child is placed in a quiet environment when the child misbehaves. The child remains in the quiet environment until the child understands the mistake and is ready to apologize for the misbehavior. The length of the time-out period is enforced by an authority figure such as a parent or caregiver with the period adjusted for the child's age. The older the child, the longer the time-out period.

For all young children, the time-out period serves as a “cooling-off” period during which the child calms down until the child is able to control their actions. For young children, a time-out functions very well to immediately correct misbehavior. The young child quickly begins to understand that loss off self-control leads to being placed in a time-out and regaining self-control leads to being able to rejoin the family or group.

As the child matures and gains cognitive skills, the child is expected to not only calm down but to reflect on their own misbehavior during the time-out period. It is hoped that as the child matures, the child begins to understand that the child's misbehavior damages the child's relationships with other children and adults. With the aid of this observation, the child begins to understand that misbehavior is not an arbitrary definition created by a contest of wills between the child and a more powerful authority figure, but that the child's misbehavior results in real harm to the child and the people that the child interacts with.

One problem that may arise with time-outs for the child is that the child may not fully understand why their misbehavior is damaging and may not understand what behavior is expected of them. One way to provide this information is for an authority figure to discuss with the child the child's misbehavior and suggest alternative behaviors. However, the presence of the authority figure during the time-out period may defeat the very purpose of the time-out period, namely providing the child with an opportunity to regain self-control without imposition of control by the authority figure. In addition, the child's misbehavior instigating the need for a time-out period may have included a conflict with the very authority figure that is now trying to educate the child. In this case, the authority figure's presence may cause the child to continue to focus on the events of the conflict rather than focus on ways in which the child may improve their behavior. Finally, the authority figure imposing the time-out period may also be emotionally upset by the child's misbehavior and may not be able to present a rational and calm explanation of the reasons the child's behavior was inappropriate.

Therefore, a need exists for a way to make an educational presentation in a non-threatening manner to a child during a time-out period. Various aspects of the present invention meet such a need.

### SUMMARY OF THE INVENTION

A method of educating a child during a time-out period is provided. A caregiver identifies a child misbehaving and isolates the child from any distractions. The caregiver then selects an educational time-out presentation from a plurality of educational time-out presentations by topic based on the child's misbehavior. After the child views the educational time-out presentation, caregiver continues to monitor the child to confirm if the child is behaving in accordance with the educational time-out presentation. Each educational time-out presentation includes a non-threatening yet authoritative figure that leads the child through an educational process wherein the child learns to make more appropriate decisions about how to behave.

In one aspect of the invention, a caregiver, such as a parent, identifies a problem behavior exhibited by a child. The caregiver selects an educational time-out presentation and presents the selected presentation to the child. The caregiver then confirms that the child performs as instructed by the educational time-out presentation.

In another aspect of the invention, identifying the problem behavior further includes monitoring the child's behavior and intervening in the child's behavior whereby the child associates the intervention with the problem behavior.

In another aspect of the invention, selecting an educational time-out presentation further includes selecting an educational time-out presentation topic from a plurality of time-out presentation topics presented by a mediated user interface.

In another aspect of the invention, the educational time-out presentation includes a calming portion and an educational portion.

In another aspect of the invention, the music accompanying a portion of the time-out presentation emphasizes the purpose of that portion. For example, the music may be calming during the calming portion or include instructional lyrics during the educational portion.

In another aspect of the invention, the educational portion includes: a scene acknowledging the child's feelings; a scene identifying the child's incorrect choices; a scene depicting a child in the presentation making an incorrect choice; a scene querying the child about a correct choice; a scene where the child in the presentation makes a correct choice; and a scene praising the child for being a person who doesn't want to make an incorrect choice.

In another aspect of the invention, the presentation incorporates a multisensory approach to teaching, for example, visually comparing right and wrong choices. Through this contrast, the child sees what is right, thus teaching proper behavior.

In another aspect of the invention, presenting the educational time-out presentation further includes isolating the child from any distractions during the presentation of the educational time-out presentation.

### BRIEF DESCRIPTION OF THE DRAWINGS

These and other features, aspects, and advantages of the present invention will be more fully understood when considered with respect to the following detailed description, appended claims, and accompanying drawings, wherein:

FIG. 1 is a block diagram depicting a time-out educational process in accordance with an exemplary embodiment of the present invention;

FIG. 2 is a flow diagram depicting a time-out educational process in accordance with an exemplary embodiment of the present invention;

FIG. 3a to FIG. 3g include frames from a storyboard for a time-out presentation in accordance with an exemplary embodiment of the present invention; and

FIG. 4 is a architecture diagram of a data processing system suitable for use as a media playback device in accordance with an exemplary embodiment of the present invention.

### DETAILED DESCRIPTION

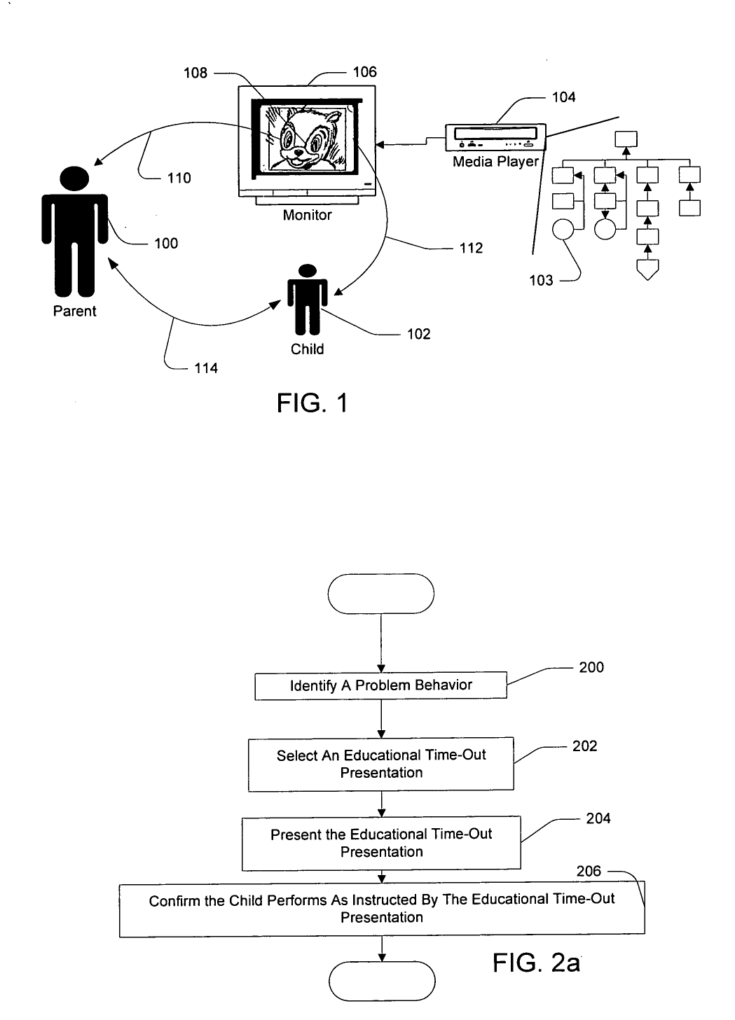

FIG. 1 is a block diagram depicting a time-out educational process in accordance with an exemplary embodiment of the present invention. A caregiver 100, such as a parent, nanny, babysitter, or other person responsible for the care of a child 102, identifies a misbehavior in the child. Misbehavior may include minor socially inappropriate actions, such as not taking turns with a toy, to potentially dangerous activities, such as pushing, hitting, or biting another child. The caregiver places the child in a time-out by separating the child from the child's playmates or other distracting environments.

The caregiver selects an educational time-out presentation topic from a plurality of time-out presentation topics presented by a user interface 103 generated by a media playback device 104, (such as a video cassette player, a DVD player, or a computer system running a computer program) and monitor device 106. Once the caregiver selects a topic, an educational time-out presentation 108 is presented to the child. The educational time-out presentation includes a portion 110 that is intended for the caregiver and a portion 112 that is intended for the child. The caregiver uses the techniques provided in the time-out presentation to monitor (114) the child's behavior and to reinforce the child's good behavior.

In slightly more detail, the portion of the time-out presentation intended for the caregiver includes an explanation of why a child might be misbehaving. By understanding the child's misbehavior, the caregiver may be in a better position to prevent the child's misbehavior. In addition, by understanding the causation of the child's misbehavior, the caregiver may be able to reduce their own sense of frustration and develop more patience when dealing with children. Finally, once the caregiver understands the causation of the misbehavior, the caregiver may be in a better position to monitor the child's behavior as the behavior relates to incorrect choices made by the child.

In addition to a discussion of the causation of the child's misbehavior, the caregiver is also given practical instructions on caregiving. These instructions include tips on how to maintain self control and patience with the child, how to teach and model the desired behavior, and how to monitor the child's future behavior.

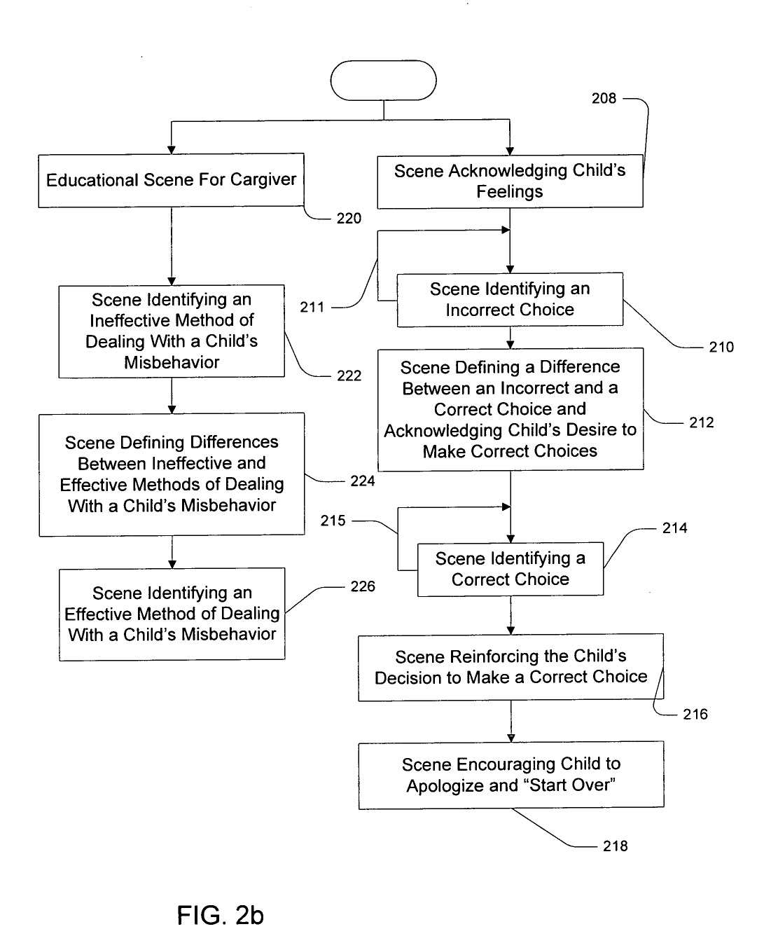

FIG. 2 is a flow diagram depicting a time-out educational process in accordance with an exemplary embodiment of the present invention. A caregiver identifies (200) a problem behavior in a child. The caregiver places the child in time-out. The caregiver then selects (202) an educational time-out presentation to present to the child. Selection of the educational time-out presentation is based on the type of misbehavior exhibited by the child. For example, the caregiver may have available a series of themed presentations available. For example, the themes may include pushing, cutting in line, whining, biting, etc. Once an educational time-out presentation has been selected, it is presented (204) to the child. After the child has watched the educational time-out presentation, the caregiver monitors (206) the behavior of the child to confirm that the child is behaving properly.

The structure of the educational time-out presentation reinforces steps in a behavioral modification method used to instruct a child and reinforce the child's commitment to behaving in a socially acceptable manner. In addition to the structure of the presentation, a non-threatening authoritative figure is used to introduce to the child the elements of proper behavior.

In another embodiment of the time-out presentation, the presentation is broadcast as part of an educational program via conventional broadcasting technology such as a television or cable broadcast.

FIG. 2b is a process flow diagram for an educational time-out presentation in accordance with an exemplary embodiment of the present invention. The educational time-out presentation includes a scene 208 wherein a non-threatening authoritative figure acknowledges the child's feelings using both dialog and song.

The presentation incorporates a multisensory approach to teaching. Scene 326 (a demonstration of bad behavior) and scene 336 (a demonstration of good behavior) for example, visually compare right and wrong choices. Through this contrast, the child sees what is right, thus teaching proper behavior.

In the presentation, songs are used to engage the child on multiple sensory levels. Firstly, the child is encouraged to learn the lyrics to the songs, thereby reinforcing the message of the presentation through auditory learning. Secondly, the child is encouraged to move in rhythm to the songs, thus reinforcing the message of the presentation through kinesthetic learning.

Another scene 210 is used to identify the child's incorrect choices. Within the scene, a live-action sequence may be used to illustrate a child in the presentation misbehaving in the same manner as the child in time-out. The scene includes a setup portion indicating a moment in time wherein the child in the presentation must come to a decision about how to behave. The choice made by the child in the presentation leads to another child or a caregiver in the presentation being hurt, angered, or disappointed by the choice made by the child in the presentation. This scene may be repeated (211) a number of times, using different children and scenarios.

In a next scene 212, the non-threatening authoritative figure reminds the child that the illustrated misbehavior leads to negative consequences for the child and reinforces the child's decision to not misbehave. In addition, the scene serves the purpose of contrasting the difference between correct behavior and incorrect behavior in the illustrated circumstances.

In another scene 214, the beginning of the misbehavior scene 210 is replayed. However, this time the child in the presentation makes a better decision, leading to greater social acceptance and harmony. This scene may be repeated (215) using different children and scenarios in accordance with the repetition of scene 210.

In another scene 216, the non-threatening authoritative figure reinforces the child's decision to behave properly by reminding the child of the desirable consequences of behaving well. In a final scene 218, the child is encouraged to apologize and make a new effort at making correct choices.

In a time-out presentation in accordance with an exemplary embodiment of the present invention, the time-out presentation includes a song incorporating lyrics reinforcing the lessons of the time-out presentation. The melodies of the songs may be taken from popular children's songs thereby making the songs appear familiar to the child and easy to sing. In learning the song, the child memorizes the lyrics, thereby memorizing the lessons of the time-out presentation.

The time-out presentation may also include a presentation for the caregiver as well. As the caregiver's presentation is not presented to the child in time-out and may be viewed only few times by the caregiver, the child's portion and the caregiver's portion are decoupled but related by subject. In this way, a caregiver may select a caregiver presentation by subject behavior just as the caregiver selects a time-out presentation. However, the caregiver need not review the caregiver portion of the time-out presentation each time the caregiver selects the child's portion of the time-out presentation.

In the caregiver's portion of the time-out presentation, the caregiver is presented with an educational scene 220 including an explanation of why a child might be misbehaving as previously described. The caregiver portion of the time-out presentation further includes a scene 222 identifying an ineffective method of dealing with a child's misbehavior. In a subsequent scene, 224, the characteristics of an ineffective method and an effective method of dealing with the child's misbehavior are discussed. In a final scene, 226, an effective method of dealing with the child's misbehavior is illustrated.

The basic format of the time-out presentation may also be used to teach children other types of behaviors. A quiet time may be established for a child outside of the context of time-out for misbehavior. This quiet time may then be used to present an educational presentation having the same general format as a time-out presentation. However, the educational presentation may focus on other types of good behavior expected of a child. For instance, a series of educational presentations may be devised for teaching etiquette or manners. Other series of educational presentations may be directed to dealing with unfounded fears or needed skills, such as study skills.

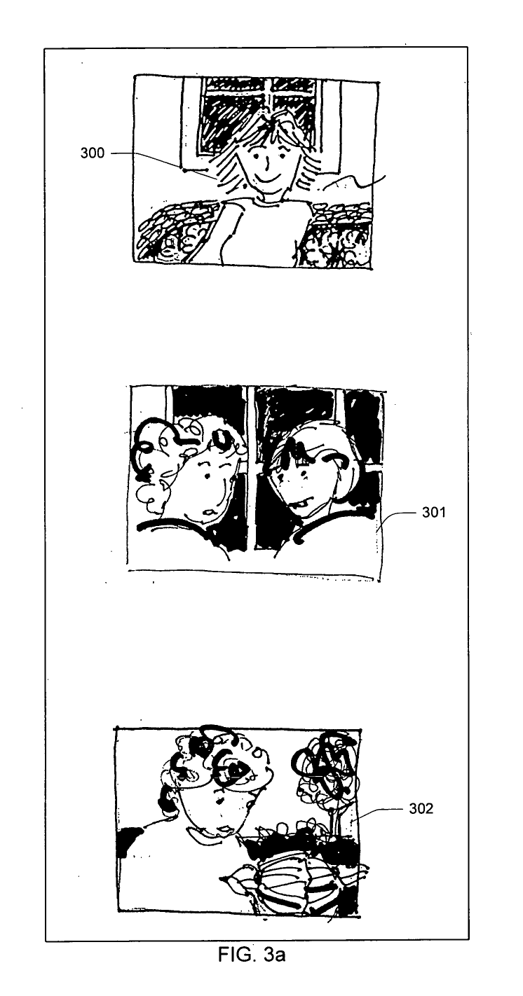

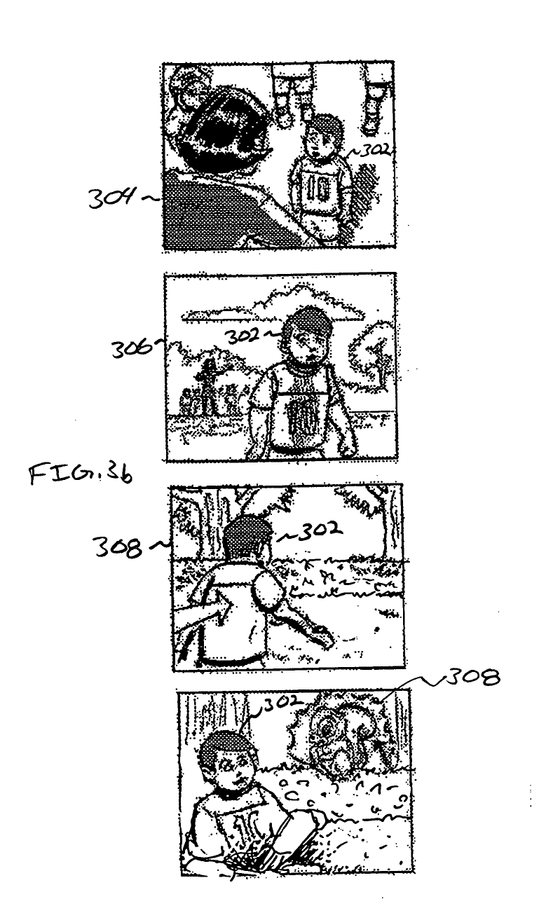

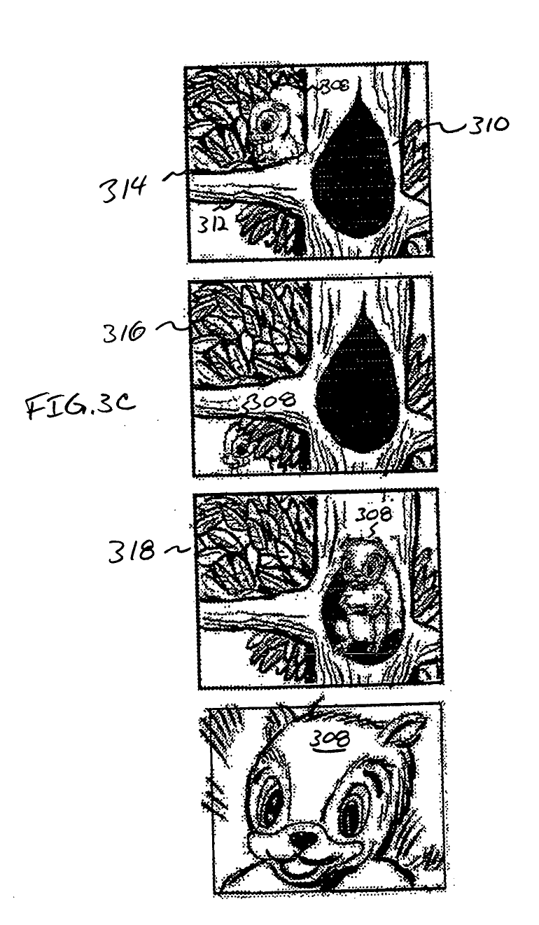

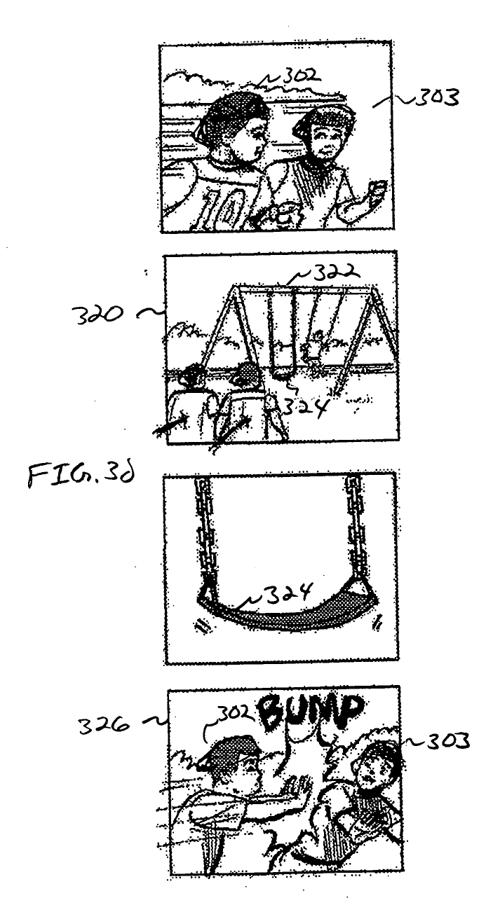

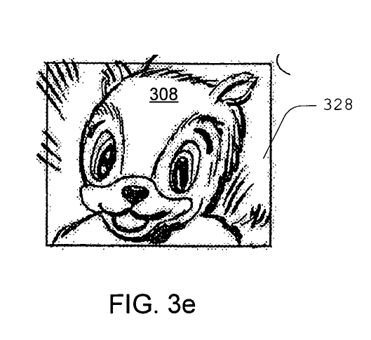

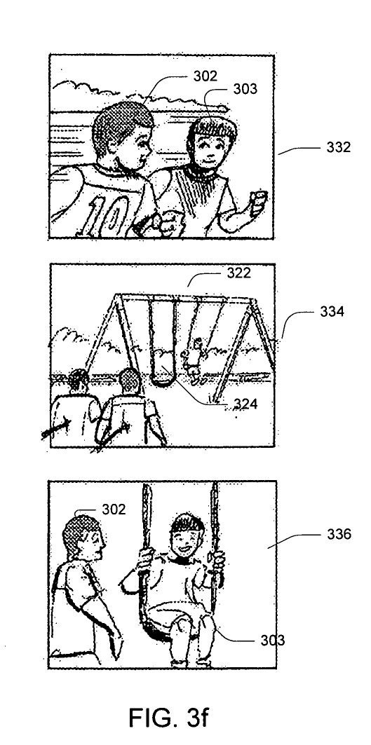

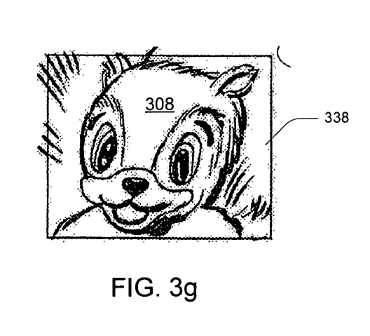

FIG. 3a to FIG. 3g are frames from a storyboard illustrating an exemplary educational time-out presentation in accordance with an exemplary embodiment of the present invention. FIG. 3a includes frames depicting an opening scene of the educational time-out presentation. The intended audience for the opening scene is a caregiver of a misbehaving child. In this scene, an actor 300, playing the part of a concerned caregiver, discusses the structure of the educational time-out presentation and suggests ways that a caregiver may use the educational time-out presentation to educate a child in time-out and reinforce approved behaviors exhibited by the child.

A discussion between caregivers is depicted in another scene 301. In the scene, the caregivers share stories related to the specific misbehavior addressed by the time-out presentation. In another scene 302, contrasting methods of dealing with a child's misbehavior are depicted. One set of methods are depicted as being ineffective. These ineffective methods are contrasted with scenes depicting effective methods.

FIG. 3b includes frames from a scene wherein a child 302 is shown receiving a time-out for his misbehavior. The music accompanying the scene includes a theme song having lyrics that reinforce the purpose of the educational time-out presentation. The lyrics are sung by a child in the presentation acknowledging their misbehavior as a mistake and asking guidance from a non-threatening yet authoritative figure as to what a proper behavior may be. During the scene, the child in the presentation accepts imposition of the time-out 304 and separation, 306 and 308, from the play group. At this point, the scene does not reveal what misbehavior resulted in the child in the presentation receiving a time-out.

Near the end of the scene, the non-threatening authoritative figure 308 appears. The non-threatening authoritative figure addresses the camera directly thereby giving the impression that the child in time-out and viewing the presentation is being addressed rather than the child in the presentation. In the exemplary educational time-out presentation, the non-threatening authoritative figure assumes the form of an anthropomorphic squirrel. The non-threatening authoritative figure sings a song with lyrics indicating that the child's misbehavior is a function of the child learning how to behave rather than an inherent feature of the child's personality. The lyrics also reinforce the child's resolve to continue to strive to improve themselves by illustrating that the child has the capacity to learn which is the key to self improvement.

FIG. 3c includes frames from a scene wherein the non-threatening authoritative figure illustrates fallibility, thus illustrating to the child that fallibility is a common characteristic. The scene also reinforces the concept that failure can be overcome through persistence and a resolve to succeed. In the scene, the non-threatening authoritative figure 308 attempts to climb into a hollow 310 of a tree 312. In a first attempt, as illustrated in frame 314, the non-threatening authoritative figure rustles in the leaves of the tree, and then pops into frame. In a second attempt, as illustrated in frame 316, the non-threatening authoritative figure 308 jumps too low and misses the hollow. In a final attempt, the non-threatening authoritative again rustles through some leaves and then pops into frame 318 and finally lands in the tree. In addition, these scenes also maintain the interest of the child in time-out through the amusing antics of the non-threatening authoritative figure and well as establish a warm relationship between the child in time-out and the non-threatening authoritative figure.

Near the end of the scene, the non-threatening authoritative figure 308 sympathizes with the child. The non-threatening authoritative figure supplies reinforcement for proper behavior by acknowledging that the child is angry and also notes that the child really doesn't want to be angry.

FIG. 3d includes frames depicting a scene wherein the child's particular misbehavior is illustrated. In this scene, the child in the presentation 302 is shown racing with a second child 303. In frame 320, the children reach a swing set 322 with only one free swing 324. In frame 326, the child in the presentation 302 pushes the second child 303 to the ground in order to gain access to the lone remaining swing. This action illustrates the misbehavior for which the child in the presentation received a time-out. As the caregiver has the opportunity to select which of several educational time-out presentations to present to the child, the misbehavior illustrated by the child in the presentation is preferably similar to the misbehavior of the child placed in time-out. Several such scenes may be repeated, each one illustrating specific instances of the particular misbehavior. In each scene, the reaction of a child or caregiver adversely affected by the misbehavior is highlighted so that the child watching the scene will understand that misbehavior affects those around the misbehaving child in an adverse way.

FIG. 3e includes frames from a scene wherein the non-threatening authoritative figure discusses the previous scenes illustrating the particular misbehavior. In frame 328, the non-threatening authoritative figure 308 again addresses the camera directly and recounts the results of the illustrated misbehavior using both song and dialog. The non-threatening authoritative figure then states what the child in time-out viewing the previous scene should have learned, namely that a misbehaving child hurts those around the misbehaving child far out of proportion to whatever the misbehaving child may have gained. This leads to the misbehaving child to be unpopular with the misbehaving child's playmates. The non-threatening authoritative figure 308 then states that the child is popular, implying that the child does not misbehave so as to harm the child in time-out's friends. The non-threatening authoritative figure reinforces this message through dialog and song as above.

FIG. 3f includes frames from a scene wherein the child's misbehavior has been corrected. In this scene, as illustrated in frame 332, we see the child in the presentation 302 and the second child 303 racing to a swing set as before. In frame 334, the children in the presentation arrive at the swing set 322 with only one available swing 324 as before. However, in frame 336, the child in the presentation 302 is seen playing cooperatively with the second child 303 on the swing. A scene showing a child's corrected misbehavior is repeated for each scene previously presented illustrating a child's misbehavior.

Through the use of a first scene illustrating a specific type of misbehavior and a second scene illustrating proper behavior in the same set of circumstances, the child is presented with an opportunity to compare and contrast the two types of behavior. In the first scene, the child is encouraged to see himself as others do while the child is misbehaving. By comparing the first and the second scene, the child can then see the contrast between the two types of behaviors including the ultimate outcome of the behaviors.

FIG. 3g includes frames from a scene wherein the non-threatening authoritative figure reinforces a child's decision to behave properly. Again, the non-threatening authoritative figure 308 addresses the camera directly giving the impression the non-threatening authoritative figure is talking directly to the viewing child. In frame 338, the non-threatening authoritative figure 308 reinforces the fact that behaving well will increase the acceptance of the child by the viewing child's playmates. The non-threatening authoritative figure then praises the child for behaving properly.

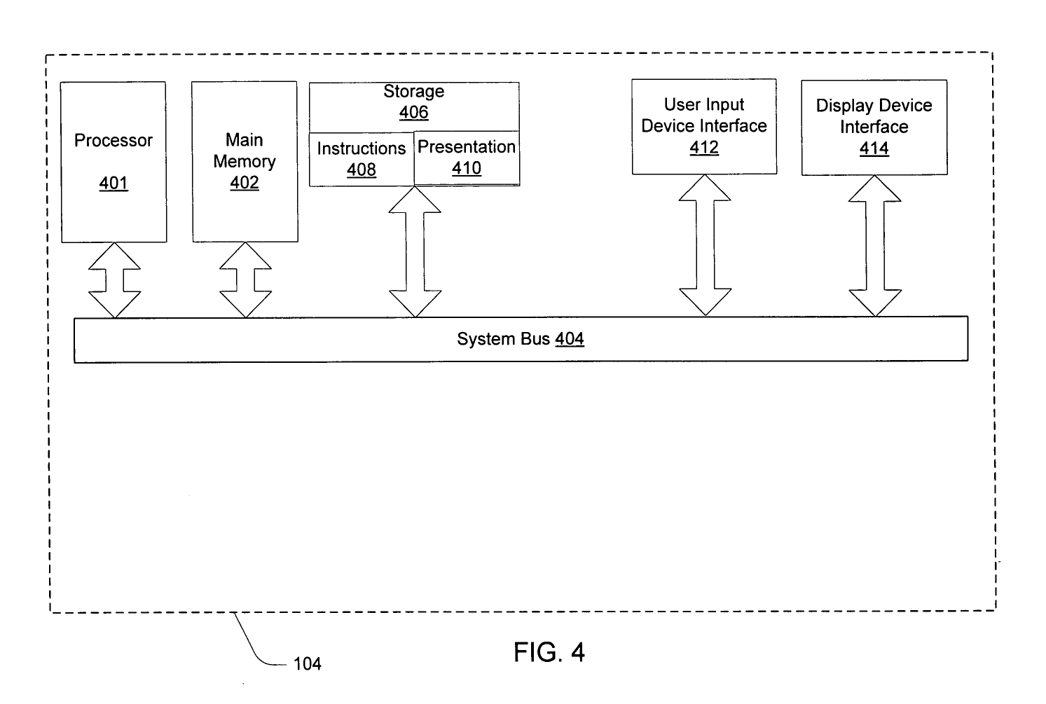

FIG. 4 is a architecture diagram of a data processing system suitable for use as a media playback device in accordance with an exemplary embodiment of the present invention. A data processing system suitable for use as a media playback device 104 includes a processor 941 coupled to a main memory 402 via a system bus 404. The processor is also coupled to a data storage device 406 via the system bus. The storage device includes programming instructions 408 implementing the features of a time-out presentation as described above. In operation, the processor loads the programming instructions into the main memory and executes the programming instructions to present a time-out presentation 410 stored in the storage device.

The media playback device may further include a user input device interface 412. The media playback device uses the user input device interface to receive selections of time-out presentations from a caregiver.

The media playback device may further include a display device interface 414. The media playback device uses the display device interface to present the time-out presentation to the child as previously described.

Although this invention has been described in certain specific embodiments, many additional modifications and variations would be apparent to those skilled in the art. It is therefore to be understood that this invention may be practiced otherwise than as specifically described. For example, the media used to store and present the educational time-out presentations may be altered without deviating from the spirit of the present invention. Thus, the present embodiments of the invention should be considered in all respects as illustrative and not restrictive, the scope of the invention to be determined by any claims supportable by this application and the claims' equivalents.

1. A method of educating a child using a media presentation device in communication with a user interface, comprising:
identifying a problem behavior exhibited by the child;
selecting through the user interface an educational time-out presentation to present to the child that corresponds to the problem behavior; and
presenting the educational time-out presentation to the child through the media presentation device,
wherein the child is educated about the problem behavior and alternate appropriate behavior.

2. The method of claim 1, wherein identifying the problem behavior further includes:
monitoring the child's behavior; and
intervening in the child's behavior whereby the child associates the intervention with the problem behavior.

3. The method of claim 1, wherein selecting an educational time-out presentation further includes selecting an educational time-out presentation topic from a plurality of time-out presentation topics presented by the user interface.

4. The method of claim 1, wherein the educational time-out presentation includes;
a calming segment; and
an educational segment.

5. The method of claim 4, wherein the educational segment includes a multimedia comparison between correct and incorrect choices, the multimedia comparison including visual, auditory, and musical depictions of the choices.

6. The method of claim 4, wherein the educational segment includes:
a scene acknowledging the child's feelings;
a scene identifying the child's incorrect choices;
a scene depicting a child in the presentation making an incorrect choice;
a scene querying the child about the child's choices, the scene contrasting a correct choice from an incorrect choice;
a scene where the child in the presentation makes a correct choice; and
a scene praising the child for being a person who wants to make a correct choice.

7. The method of claim 6, wherein the scene acknowledging the child's feelings includes a song segment.

8. The method of claim 6, wherein the scene querying the child about the child's choices includes a song segment.

9. The method of claim 1, wherein presenting the educational time-out presentation further includes isolating the child from any distractions during the presentation of the educational time-out presentation.
